(19) United States
(12) Patent Application Publication
(10) Pub. No.: US 2010/0209874 A1
(43) Pub. Date: Aug. 19, 2010

(54) ARRANGEMENT FOR FORMING A BAR CONSTRUCTION AND A FIXATION SCREW THEREFOR

(75) Inventors: Adrian Auderset, Nidau (CH); Markus Bluemli, Biel/Bienne (CH); Mathias Strazza, Meinisberg (CH); Jean-Fred Studer, Lamboing (CH); Hans Messerli, Biel/Bienne (CH)

Correspondence Address: FOLEY AND LARDNER LLP;SUITE 500, 3000 K STREET NW, WASHINGTON, DC, 20007, US

(73) Assignee: Cendres+Metaux SA

(21) Appl. No.: 12/733,426

(22) PCT Filed: Sep. 12, 2007
(86) PCT No.: PCT/CH2007/000447

§ 371 Date: Mar. 1, 2010

(51) Int. Cl. A61C 8/00

(52) U.S. Cl. 433/174

(57) ABSTRACT

The arrangement for forming a bar construction, to which a prosthesis can be fastened, may comprise: a first connecting element with a first end which has a through-opening through which an end of a fixation screw can be passed in order to fasten the first connecting element in a specific angular position in relation to an implant, and a second end which is connectable with a bar, and a second connecting element, which is connectable by a releasable connection to the first connecting element, and securing means for counteracting a separation of the two connecting elements from each other when these are connected and moved. The two connecting elements may each comprise an end that has a substantially spherical inner face and a substantially spherical outer face. The head of a fixation screw may have a first substantially spherical outer face and a second substantially conical outer face.

The present invention relates to an arrangement for forming a bar construction and a fixation screw therefor.

To mount dental prostheses securely, use is made of bar constructions, which can be fastened to implants. If the implants are not arranged parallel to one another on the jawbone, then precautionary measures have to be provided on the bar construction in order to be able to adapt it to the angular position of the implants.

U.S. Pat. No. 5,219,286 discloses an arrangement of loose connecting elements that are fastened with a further connecting element in the form of a fixation screw. The connecting elements have small dimensions and are therefore awkward to handle. If the bar construction is to be positioned in the mouth, there is a risk that an individual connecting element may fall into the patient's throat, will be swallowed and in the worst case may enter the airways or even the lungs (aspiration). The arrangement also has the disadvantage that the bar construction formed has a relatively large height.

EP 393 324 A1, DE 42 11 561 A1 and U.S. 2004/0078040 A1 disclose further arrangements with several loose connecting elements. These also have small dimensions, resulting in the above-mentioned disadvantages in respect of handling.

Starting from this state of the art, it is a first objective of the invention to produce an arrangement for forming a bar construction that is easier to handle.

An arrangement that solves this problem is specified in claim 1.

A second objective of the invention is to specify an arrangement and a fixation screw that allows a bar construction with a smaller height. That problem is solved by an arrangement according to claim 11 and a fixation screw according to claim 16.

The further claims specify preferred embodiments of the arrangement and the fixation screw.

The invention is explained in the following by means of exemplary embodiments with reference to Figures. In the drawings:

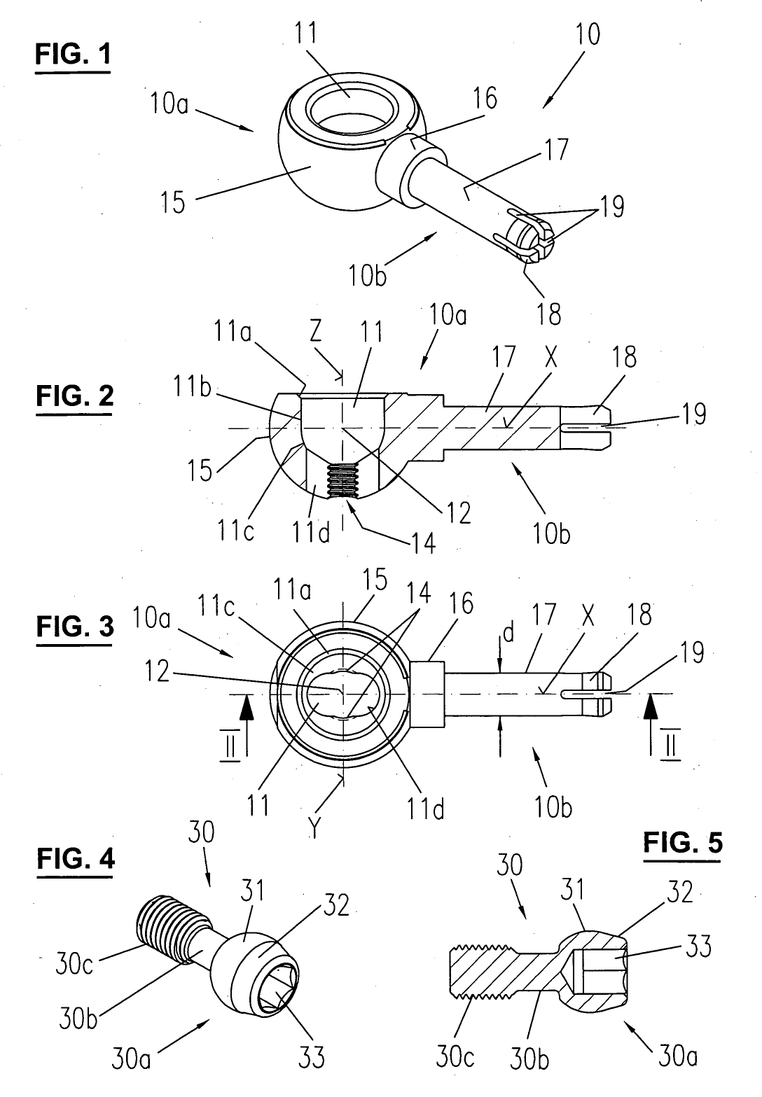

FIG. 1 shows a perspective view of a joint part according to the invention for forming a first embodiment of a bar construction;

FIG. 2 shows the joint part according to. FIG. 1 in a section along the line II-II in FIG. 3;

FIG. 3 shows a plan view of the joint part according to FIG. 1;

FIG. 4 shows a perspective view of a fixation screw for fixing the joint part according to FIG. 1;

FIG. 5 shows the fixation screw according to FIG. 4 in a sectional side view;

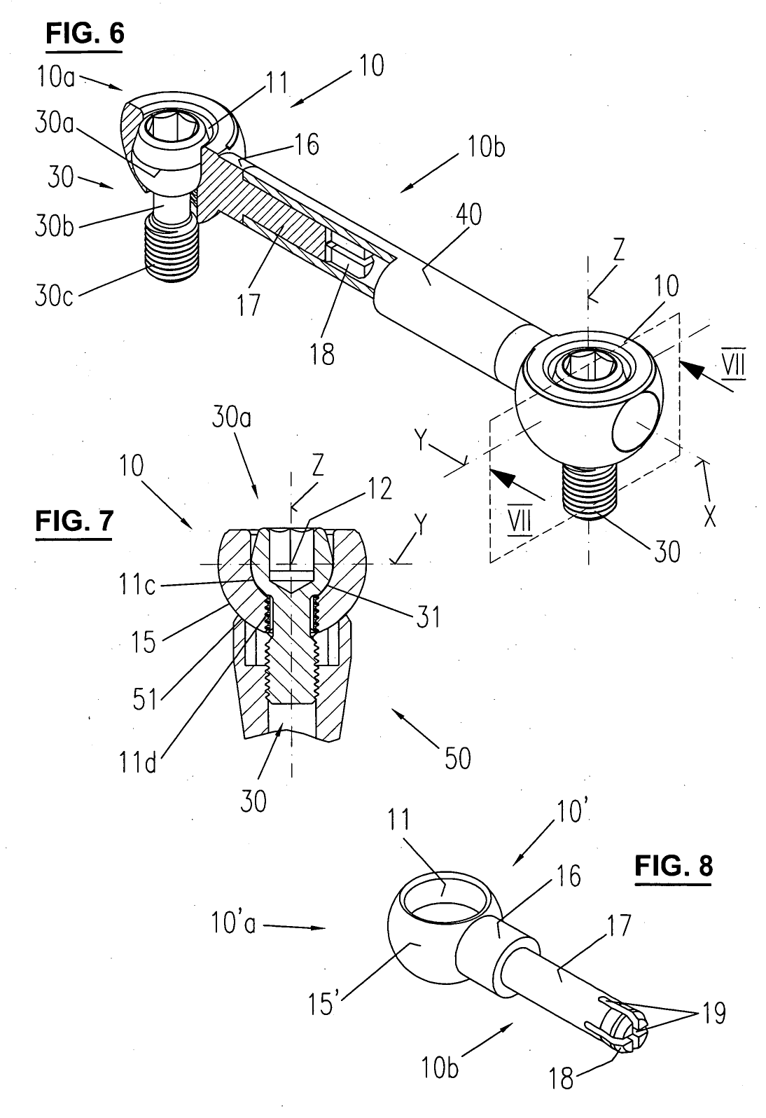

FIG. 6 shows a perspective, partially cutaway view of a first embodiment of the bar construction with joint parts according to. FIG. 1 and fixation screws according to FIG. 4;

FIG. 7 shows the bar construction according to FIG. 6 resting on abutments in the plane of section VII-VII in FIG. 6;

FIG. 8 shows a perspective view of a first joint part according to the invention for forming a second embodiment of a bar construction;

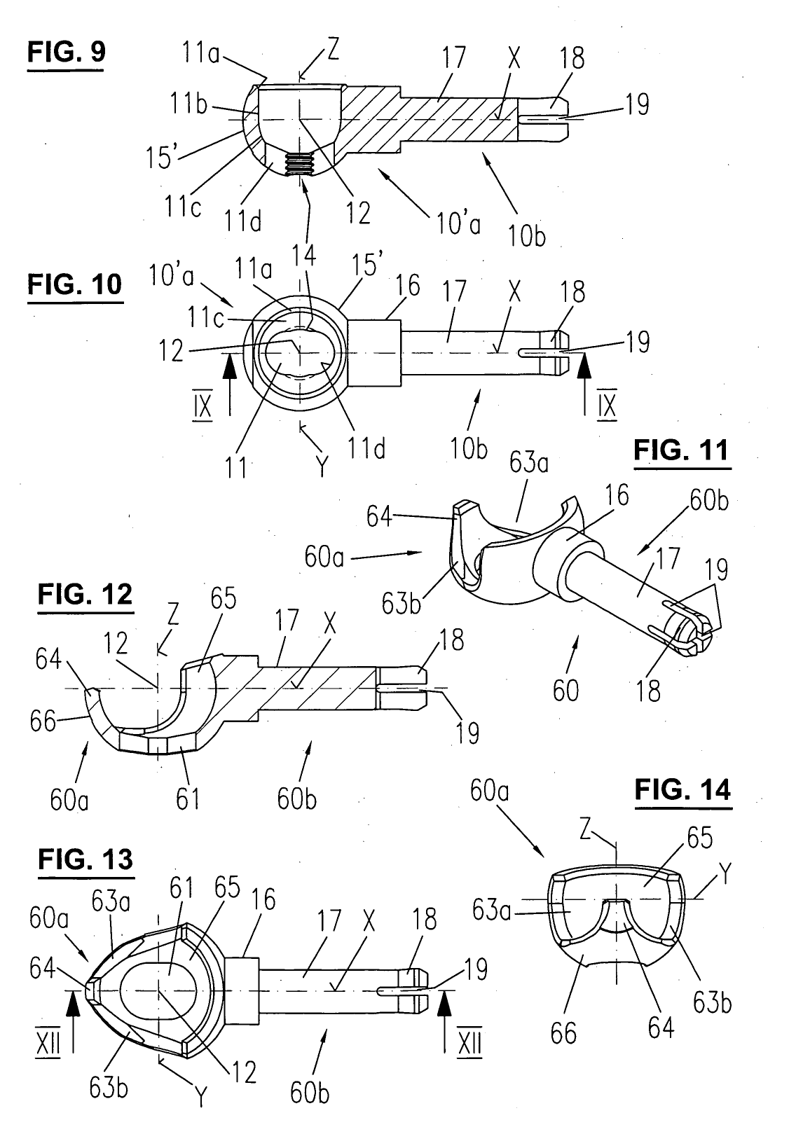

FIG. 9 shows the joint part according to FIG. 8 in a section along the line IX-IX in FIG. 10;

FIG. 10 shows a plan view of the joint part according to FIG. 8;

FIG. 11 shows a perspective view of .a second joint part according to the invention for forming the second embodiment of a bar construction;

FIG. 12 shows the joint part according to FIG. 11 in a section along the line XII-XII in FIG. 13;

FIG. 13 shows a plan view of the joint part according to FIG. 11;

FIG. 14 shows a front view of the joint part according to FIG. 11;

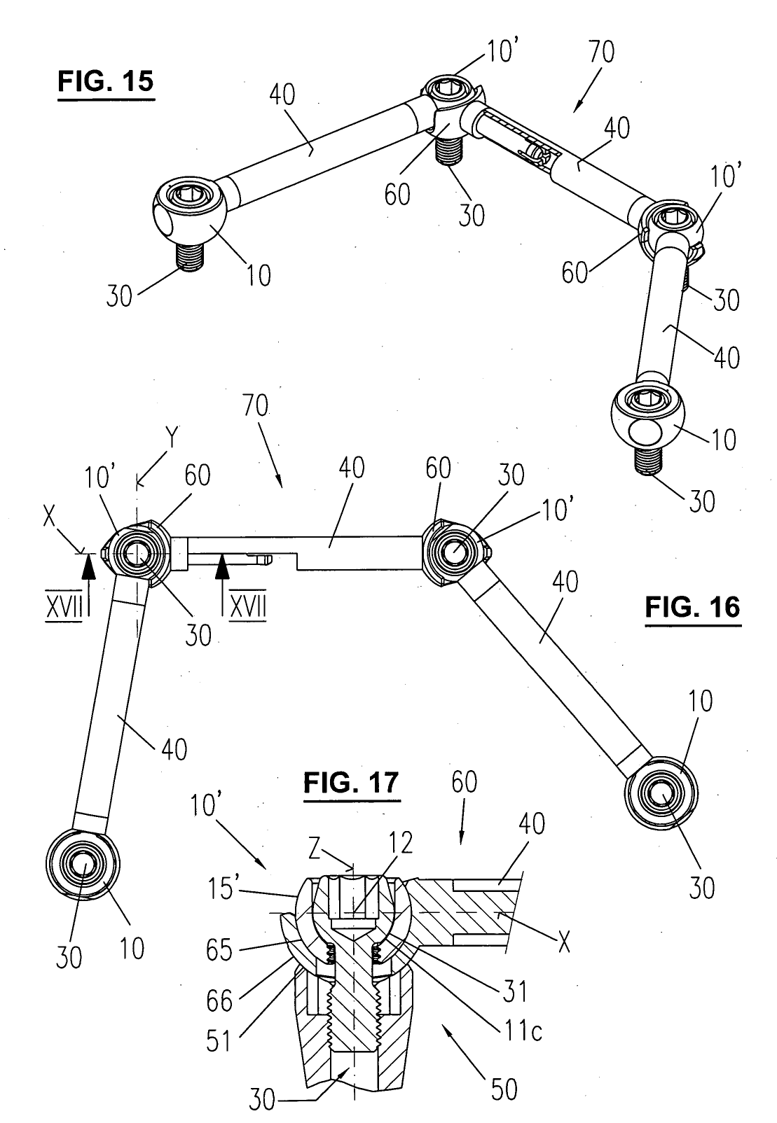

FIG. 15 shows a perspective, partially cutaway view of a second embodiment of the bar construction with joint parts according to FIGS. 1, 8 and 11 plus fixation screws according to FIG. 4;

FIG. 16 shows a plan view of the bar construction according to FIG. 15; and

FIG. 17 shows the bar construction according to FIG. 15 resting on abutments in the plane of section XVII-XVII in FIG. 16.

### FIRST EXEMPLARY EMBODIMENT OF A BAR CONSTRUCTION

The joint part 10 shown in FIGS. 1 to 3 and the fixation screw 30 shown in FIGS. 4 and 5 are connecting elements for forming a bar construction, as shown in FIGS. 6 and 7.

As is evident from FIGS. 1 to 3, the joint part 10 comprises an annular end 10a, from which laterally a rod-form end in the form of a stud 10b extends. The two ends 10a and 10b are rigidly connected to one another, by, for example, the joint part 10 being manufactured in one piece. The annular end 10a has a through-opening 11, which runs transversely to the longitudinal direction of the stud 10b, as is apparent from the dashed axis lines x and z drawn in FIG. 2.

The form of the through-opening 11 is defined by a face that is composed of the following inner faces, viewed from the occlusal end to the apical end:
a first, tapering inner face 11a,
a second, substantially circular-cylindrical inner face 11b,
a third, substantially spherical inner face 11c, which serves as a ball socket for the fixation screw 30,
and
a fourth, inner face lid formed by an elongated hole, which is provided with an internal thread 14, the configuration of which is matched to the thread of the fixation screw 30. The elongated hole extends in the longitudinal direction 13 of the stud 10b.

The outer face 15 of the annular end 10a is substantially spherical and after assembly abuts a spherical support face.

The spherical inner face 11c and the spherical outer face 15 are each located on a sphere. The two spheres have a different radius, but the same center 12, which corresponds to the point of intersection of the three axis lines x, y and z drawn in FIGS. 2 and 3.

The stud 10b has a collar 16 adjoining which is a circular-cylindrical portion 17, which becomes a stud end 18.

The portion 17 has an outer diameter d, which is adapted to correspond to the inner diameter of the tubular bar to be received.

The stud end 18 is provided with one or more slots 19 and widens radially outwards. This configuration produces clamping means in the form of resilient tongues, which press against the tubular bar when this is pushed onto the stud 10b.

The fixation screw 30 shown in FIGS. 4 and 5 comprises a screw head 30a, which is connected by way of a neck 30b to a screw end 30c provided with a thread.

In the assembled state, the joint part 10 and fixation screw 30 form a ball joint. For that purpose, the outer face 31 of the screw head 30a adjoining the neck 30b is substantially spherical and after insertion into the joint part 10 abuts the spherical inner face 11c. Between the spherical outer face 31 and the free end of the screw head 30a the outer face 32 is conical. If in the assembled state the fixation screw 30 is tilted relative to the joint part 10, then part of the conical outer face 32 abuts the circular-cylindrical inner face 11b of the joint part 10.

The screw head 30a is provided with a recess 33, the cross-section of which differs from a circular form and is, for example, multisided. To attach the fixation screw 30, a screwdriver with an end complementary to the shape of the recess 33 is inserted therein.

As FIG. 5 in particular shows, the diameter of, the neck 30b is smaller then the diameter of the thread 30c. The length of the neck 30b is larger than the length of the thread 14 in the joint part 10.

The joint part 10 and fixation screw 30 are joined together by inserting the screw end 30c into the through-opening 11 of the joint part 10 and screwing it into the thread 14. The fixation screw 30 is then turned until the screw end 30c is screwed completely through the thread 14 and the neck 30b comes to lie in the elongated hole 11d. Viewed in the plan view according to FIG. 3, the elongated hole lid has dimensions that are larger than the neck 30b, yet smaller than the screw end 30c. The joint part 10 and the fixation screw 30 are therefore movable, in particular pivotable, relative to one another, without the fixation screw 30 being able to become detached from the joint part 10.

FIG. 6 shows a bar construction with two joint parts 10, in each of which a fixation screw 30 is inserted, and with a connecting element in the form of a bar 40, which is connected to the two joint parts 10.

The bar 40 is in the form of a tube, which has a circular inner contour and a circular outer contour. The inner diameter of the tubular bar 40 corresponds to the outer diameter d of the circular-cylindrical portion 17 of the second end 10b of the joint part 10. The diameter of the collar 16 is matched to the diameter of the tubular bar 40, so that a substantially continuous transition is formed. By virtue of the resiliently constructed stud end 18, the joint part 10 is held at the tubular bar 40 in such a way that the two parts 10 and 40 are movable relative to one another, yet a separation of the connection is prevented. As the stud 10b is inserted in the tubular bar 40, a certain force has to be overcome, and also has to be applied when the two parts 10 and 40 are to be separated again subsequently.

The bar construction can be fastened to two implants that are fixed in the jawbone of the patient. For that purpose, the user, for example, the dentist or dental technician, cuts the tubular bar 40 to correspond to the given distance between the two implants, screws the fixation screws 30 into the joint parts 10 until the screw ends 30c emerge from the bottom of the joint parts 10 and inserts the studs lob into the tubular bar 40. The individual connecting elements 10, 30, 40 are then joined together to form an aggregate construction in such a way that they are securely held together yet are movable relative to one another. This prevents an individual connecting element from becoming detached as the construction is positioned in the mouth of the patient and possibly being swallowed by him.

Spherical support faces 51, which the joint parts 10 abut with their outer faces 15, are used to mount the bar construction, as shown in FIG. 7. The respective support face 51 is, for example, part of a connecting element 50 in the form of an abutment, which is fastened to the implant, for example, by means of a screw connection. An abutment is understood to be any suitable connecting component by means of which the bar construction can be fastened to an implant. It is also possible to provide the support face 51 directly on the implant.

In the assembled state, the support face 51 lies on a sphere, the center of which coincides with the center. 12 of the spherical faces 11c and 31. The joint part 10 and fixation screw 30 as well as the joint part 10 and support face 51 each form a ball joint. The fixation screw 30 and the implant extend in the assembled state in the direction of the z-axis line. In FIGS. 6 and 7, the situation in which the two implants are arranged parallel to one another is shown. In this “ideal state”, the joint part 10 is aligned in the z-direction, so that the bar 40 is arranged at right angles thereto. Depending on the given angular position of the implants, the respective joint part 10 will be tilted in relation to the fixation screw 30. The spherical faces 11c and 31 as well as 15 and 51 enable the joint part 10 to pivot in all directions. By virtue of the geometry of the elongated hole lid, the joint part 10 can be tilted in the xz plane by a larger tilting angle than in the yz plane.

The dental prosthesis can be fastened to the bar 40 by known means, e.g. matrices.

Irrespective of the tilting angle of the joint part 10, the screw head 30a is largely received in the through-opening 11. This counter-sinking of the fixation screw 30 results in a small height of the bar constructions.

### SECOND EXEMPLARY EMBODIMENT OF A BAR CONSTRUCTION

The first joint part 10′ shown in FIGS. 8 to 10 and the second joint part 60 shown in FIGS. 11 to 14 are connecting elements for forming a bar construction for four implants, as shown in FIGS. 15 to 17.

The first joint part 10′ according to FIGS. 8 to 10 is of substantially the same construction as the joint part 10 according to the first exemplary embodiment, the same reference numerals being used for the same elements. The joint part 10′ differs from the joint part 10 essentially in that the wall thickness of the annular end 10′a is smaller and consequently the outer face 15′ lies on a sphere having a radius smaller than the sphere radius of the outer face 15.

The second joint part 60 shown in FIGS. 11 to 14 is used to enable an additional bar to be mounted on an implant. The joint part 60 comprises a joint end 60a and a rod-form end 60b , which extends laterally from the joint end 60a and is rigidly joined thereto. The rod-form end 60b is advantageously of the same construction as the end 10b of the joint parts 10 and 10′.

The joint end 60a has a through-opening 61 through which the end of the fixation screw 30 can be pushed. The through-opening 61 is in the form of an elongated hole, which extends in the direction of the end 60b and the cross-section of which is made somewhat larger than the elongated hole 11d.

The joint end 60a is in the form of a bowl. The bowl has two lateral recesses 63a and 63b, through which in each case the end 10b of the first joint part 10′ can project, as well as a finger 64 arranged between the recesses 63a and 63b.

The joint end 60a serves, on the one hand, as a ball socket for the first joint part 10′ and for that purpose has a substantially spherical inner face 65, which the outer face 15′ of the joint part 10′ can abut and which extends, viewed in the z-direction, above the level of the finger 64.

On the other hand, the joint end 60a, together with the support face that it abuts after assembly, forms a further ball joint. For that purpose, the joint end 60a has a substantially spherical outer face 66. The faces 65 and 66 each lie on spheres having a common center 12, which coincides, after assembly, with the center 12 about which the first joint part 10′ is pivotable.

The finger 64 is of resilient construction, so that when it is subjected to an applied force its position in relation to the end 60b alters, and when the force is discontinued the finger 64 again assumes its original position. The radius of the spherical face 65 is selected to be a little smaller than the radius of the spherical face 15′. If the end 10′a is clipped into the end 60a, a snap-action connection that prevents disengagement is formed between the first joint part 10′ and the second joint part 60. The finger 64 at the same time presses against the end 10′a so that clamping occurs between the end 10′a and the end 60a.

The wall thickness of the joint end 60a is preferably selected so that the outer face 65 is spaced the same distance from the center 12 as the outer face 15 of the joint part 10 of the first exemplary embodiment.

The connecting elements 10, 10′, 30, 40 and 60 can each be manufactured in one piece. If necessary, however, they can be manufactured from several pieces and then be joined together to form the individual connecting elements. Suitable materials for manufacture are materials resistant to the oral environment, for example, metal, in particular titanium, such as pure titanium. The same material as that of the implant can be used. The outer contours of the connecting elements 10, 10′, 30, 40 and 60 are preferably rounded, to counteract inter alia the risk of injuries.

The connecting elements 10, 10′, 30, 40 and 60 can be joined together to form a bar construction 70, as shown in FIGS. 15 to 17. Here, the hole lid with the thread 14 in the joint parts 10 and 10′, the finger 64 in the case of the joint part 60 and also the stud end 18 with the slots 19 in the case of the joint parts 10, 10′ and 60 act as securing means, which ensure that the connection between the individual connecting elements 10, 10′,30, 40 and 60 does not become disengaged when these move.

The bar construction 70 is finally fastened to the four implants, for example, by means of abutments 50 or directly to the implants. As in the case of the first exemplary embodiment, the bar construction 70 abuts spherical support faces 51. The joint parts. 10 at the two ends of the bar construction 70 are fastened as in the case of the first exemplary embodiment (cf. FIG. 7), whereas the joint parts 10′ and 60 arranged between them are mounted as shown in FIG. 17.

In the assembled state, the fixation screw 30 and the joint part 10′ form a first ball joint, the joint part 10′ and the joint part 60 form a second ball joint and the joint part 60 and support face 51 form a third ball joint. FIG. 17 shows the state in which the bars 40 mounted at the two joint parts 10′ and 60 are arranged exactly at right angles to the z-axis line, along which the implant extends. The two joint parts 10′ and 60 are pivotable independently of one another relative to the fixation screw 30 and around the common center 12, and can be pivoted in all directions. In particular, the joint part 10′ as well as the joint part 60 can be pivoted in the xz plane upwards and downwards and in the xy plane to and fro. In FIG. 16, the left-hand bar 40 is pivoted inwards to the maximum and the right-hand bar 60 is pivoted outwards to the maximum.

The wall thickness of the joint end 10a corresponds preferably substantially to the sum of the wall thickness of the joint end 10′a and the wall thickness of the joint end 60a, so that the outer face 15 of the joint part 10 is spaced the same distance from the center 12 as the outer face 66 of the joint part 60. For all implants, the center 12 is therefore located at the same level, viewed in the z direction.

Unless already defined, the concept of the connecting elements described here provides many advantages:

The individual connecting elements 10, 10′, 30, 40 and 60 can be joined to form an aggregate structure in such a way that they are unable to become disengaged from one another accidentally, yet still remain movable with respect to one another. This makes handling much easier. The bar construction can also be adapted directly to the given conditions of the patient's mouth and can be mounted in a simple manner on the implants. Furthermore, as the bar construction is being adapted and mounted, the securing means 11d, 14, 30c, 18, 19 and 64 eliminate the risk that an individual connecting element could become detached and be swallowed by the patient. In particular, a safeguard against aspiration is afforded, since an individual connecting element is prevented from getting into the patient's airways.

Divergences in the implant directions can easily be compensated, in fact in all directions.

The connecting elements 10, 10′, 30, 40 and 60 can be mounted in such a manner that the bar construction is in a substantially stress-free state. Soldering or lasing, which may lead to stresses, is not required.

The connecting elements 10, 10′, 30, 40 and 60 can be joined to one another by means of a releasable connection.

The bar construction can be removed from the mouth again and, as needed, individual connecting elements can be replaced.

The bar construction has a small height. Consequently, the shaping of the connecting elements 10′ and 60 and also 30 ensures inter alia that the fastening of two bars to one and the same implant has a small height.

A small number of different connecting elements is sufficient to be able to adapt the bar construction to the given requirements.

The connecting elements can be pre-fabricated. The dentist is able to carry out all the steps needed to adapt and insert the bar construction directly at his practice. No complicated procedures such as soldering, casting etc., are needed. Directly after mounting the bar construction in the patient's mouth, it can be subjected to load.

The use of abutments enables the bar construction to be adapted to different types of implant and to the desired height in the mouth.

From the preceding description, many modifications are available to the skilled person without departing from the scope of the invention, which is defined in the claims.

The connecting elements shown here can be used for two, three or more implants.

The outer contour of the bar 40 need not necessarily be circular, but may also be of a different. form.

Instead of a tubular bar 40 into which the studs 10b and 60b are inserted, a complementary connection is possible, in which the rod-form end 10b and 60b is in the form of sleeve and the bar is in the form of a rod that is insertable into the sleeve.

The collar 16 of the second joint part 10′ can additionally have a circumferential groove, so that the outer face 15′ is enlarged and the maximum angle through which the joint part 10′ is pivotable in the xy plane is enlarged.

The stud end 18 need not necessarily be prefabricated in an expanding form to achieve an application of force on the bar. It is also possible for the stud end to be designed to be activatable, by providing the stud with a slot and pressing apart the resulting tongues by means of a tool before the connecting elements are assembled.

To secure the connection between the fixation screw 30 and the joint parts 10′ or 10′ and 60, it is also possible to provide an O-ring, which is mounted on the fixation screw 30.

1-18. (canceled)

19. An arrangement with connecting elements, which are connectable with each other for forming a bar construction, which can be positioned in a mouth for fastening a prosthesis, comprising:
a first connecting element having
a first end which has a through-opening through which an end of a fixation screw can be passed in order to fasten the first connecting element in a specifiable angular position in relation to an implant, and
a second end which is connectable with a bar;
a second connecting element, which is connectable by a releasable connection to the first connecting element such that the first and second connecting elements are movable relative to one another; and
securing means for counteracting a separation of the first and second connecting elements from each other when the first and second connecting elements are connected and moved.

20. An arrangement according to claim 19, wherein the second connecting element is the fixation screw and the securing means comprises a thread formed in the through-opening, through which the end of the fixation screw may be screwed.

21. An arrangement according to claim 20, wherein the through-opening has an elongated hole that contains the thread.

22. An arrangement according to claim 19, wherein the first end of the first connecting element is of bowl-form construction and is arranged to be connected by a snap-action connection to a third end of the second connecting element.

23. An arrangement according to claim 22, wherein the first end has a finger.

24. An arrangement according to claim 19, wherein the second end of the first connecting element is in a form of a rod and the second connecting element is the bar, which is fastenable to the second end.

25. An arrangement according to claim 24, wherein the securing means comprises a clamping means arranged at the second end for applying a force to the bar.

26. An arrangement according to claim 25, wherein the second end has at least one slot to form the clamping means and/or is designed to open out.

27. An arrangement according to claim 19, wherein the first end of the first connecting element comprises a substantially spherical outer face and/or a substantially spherical inner face.

28. An arrangement according to claim 19, wherein the second connecting element has an end that comprises a substantially spherical outer face and/or a substantially spherical inner face.

29. An arrangement according to claim 19, further comprising at least one abutment, which is fastenable to the implant and comprises a spherical support face.

30. An arrangement for forming a bar construction, to which a prosthesis is fastenable, comprising:
a first connecting element having
a first end, which has a first through-opening, and
a second end, which is connectable to a first bar; and
a second connecting element having
a third end, which has a second through-opening, and
a fourth end, which is connectable to a second bar; wherein, in each case, the first end and the third end comprise a substantially spherical inner face and a substantially spherical outer face.

31. An arrangement according to claim 30, wherein the first end of the first connecting element is of bowl-form construction and is connectable by a snap-action connection to the second connecting element.

32. An arrangement according to claim 30, wherein the first end is of annular construction, in which a head of a fixation screw can be countersunk.

33. An arrangement according to claim 30, wherein both the first and second ends of the first connecting element are rigidly connected to one another and manufactured in one piece.

34. A fixation screw for an arrangement according to claim 30, comprising:
a head, which is connected by way of a neck to a threaded end,
wherein the head comprises a first substantially spherical outer face and a second substantially conical outer face,
wherein the first outer face adjoins the second outer face and/or a diameter of the neck is smaller than a diameter of the threaded end.

35. A fixation screw according to claim 34, wherein the head has a recess that is multisided.
